(19) United States
(12) Patent Application Publication
(10) Pub. No.: US 2021/0334619 A1
(43) Pub. Date: Oct. 28, 2021

(54) PORTABLE ELECTRONIC DEVICE AND ELECTRONIC SYSTEM

(71) Applicant: PEGATRON CORPORATION, TAIPEI CITY (TW)

(72) Inventors: Kai Yao Hu, Taipei City (TW); Chien Hsun Wu, Taipei City (TW); Wei Hsiang Lee, Taipei City (TW)

(73) Assignee: PEGATRON CORPORATION, TAIPEI CITY (TW)

(21) Appl. No.: 17/196,724

(22) Filed: Mar. 9, 2021

(30) Foreign Application Priority Data
Apr. 28, 2020 (TW) 109114210

(51) Int. Cl. G06K 19/14; G06K 19/07; G06K 19/04

(52) U.S. Cl. CPC G06K 19/145; G06K 19/041; G06K 19/0725

(57) ABSTRACT

A portable electronic device adapted for connecting to a base is provided. The base has a first connector and an RFID tag. The portable electronic device includes a casing, a second connector, a cover, a control module and an RFID sensor. The second connector is disposed on a lateral surface of the casing and is adapted for connecting to the first connector. The cover is movably disposed on the lateral surface of the casing and corresponds to the second connector, so as to cover or expose the second connector. The RFID sensor is disposed in the casing and is adjacent to the lateral surface. The RFID sensor detects the RFID tag to generate a signal. The control module is disposed in the casing and coupled to the RFID sensor and the cover. The control module controls the cover to move to expose the second connector according to the signal.

### CROSS-REFERENCE TO RELATED APPLICATION

This application claims the priority benefit of Taiwan application serial no. 109114210, filed on Apr. 28, 2020. The entirety of the above-mentioned patent application is hereby incorporated by reference herein and made a part of this specification.

### BACKGROUND

### Technical Field

The disclosure relates to a portable electronic device and an electronic system, and in particular to a portable electronic device and an electronic system that protect a connector thereof.

### Description of Related Art

An existing portable electronic device has pins that are exposed regardless of whether a connector of the portable electronic device is connected or not, thereby causing risks of the pins being impacted and short circuited. Also, the exposed pins are also prone to oxidation. If the connector is covered by a cover, when the connector connects to an external device, the cover needs to be manually removed, which is inconvenient in operation and causes a risk of losing the cover.

### SUMMARY

The disclosure provides a portable electronic device. The portable electronic device has a connector which is covered by a cover. In a process of the portable electronic device connecting to a base, the cover may automatically move open to expose the connector.

The disclosure provides an electronic system which is equipped with the portable electronic device.

The portable electronic device in the disclosure is adapted for connecting with a base. The base includes a first connector and an RFID (radio frequency identification) tag. The portable electronic device includes a casing, a second connector, a cover, a control module, and an RFID sensor. The casing includes a lateral surface. The second connector is disposed on the lateral surface of the casing and is adapted for connecting to the first connector. The cover is movably disposed on the lateral surface of the casing and corresponds to the second connector to cover or expose the second connector. The RFID sensor is disposed in the casing and is adjacent to the lateral surface, and the RFID sensor is adapted for detecting the RFID tag to generate a signal. The control module is disposed in the casing and is coupled to the RFID sensor and the cover. The control module controls the cover to move to expose the second connector according to the signal.

The electronic system of the disclosure includes a base and a portable electronic device. The base includes a first connector and an RFID tag. The portable electronic device includes a casing, a second connector, a cover, a control module, and an RFID sensor. The casing includes a lateral surface. The second connector is disposed on the lateral surface of the casing and is adapted for connecting to the first connector. The cover is movably disposed on the lateral surface of the casing and corresponds to the second connector to cover or expose the second connector. The RFID sensor is disposed at the casing and is adjacent to the lateral surface, and the RFID sensor is adapted for detecting the RFID tag to generate a signal. The control module is disposed in the casing and is adapted to control the movement of the cover. The RFID sensor is disposed in the casing and coupled to the RFID sensor and the cover. The control module controls the cover to move to expose the second connector according to the signal, so that the second connector connects to the first connector of the base.

Based on the above, the cover of the portable electronic device of the disclosure is movably disposed at the casing to cover or expose the second connector. When the portable electronic device is away from the base, the cover covers the second connector. When the portable electronic device approaches the base and the RFID sensor detects the RFID tag of the base, the RFID sensor generates a signal and transmits the signal to the control module to enable the control module to control the cover to move to expose the second connector, so that the second connector of the portable electronic device may connect to the first connector of the base. The second connector of the portable electronic device of the disclosure is covered by the cover when the second connector is not connected. Accordingly, the second connector may avoid being directly impacted and may also avoid experiencing short circuited caused by an accidental contact with a metal element, and the probability of oxidation of the second connector is reduced. In addition, the cover may automatically open and close as the portable electronic device approaches or moves away from the base, thereby providing convenience in operation.

### BRIEF DESCRIPTION OF THE DRAWINGS

FIG. 1A is a schematic view of a portable electronic device according to an embodiment of the disclosure.

FIG. 1B is a partial schematic view of the portable electronic device of FIG. 1A.

FIG. 2A is a schematic view of the portable electronic device of FIG. 1A with a second connector thereof exposed.

FIG. 2B is a partial schematic view of the portable electronic device of FIG. 2A.

FIG. 3 is a schematic view of the portable electronic device and a base of FIG. 1A.

FIG. 4 is a schematic view of a moving cover of another portable electronic device according to an embodiment of the disclosure.

### DESCRIPTION OF THE EMBODIMENTS

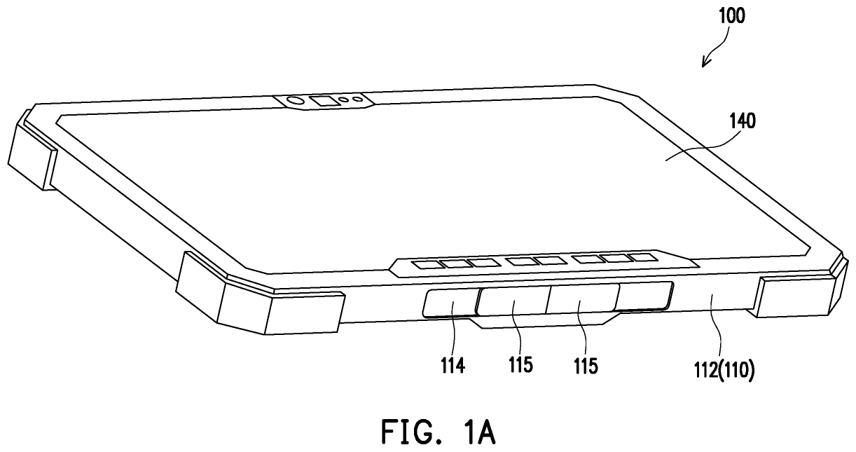

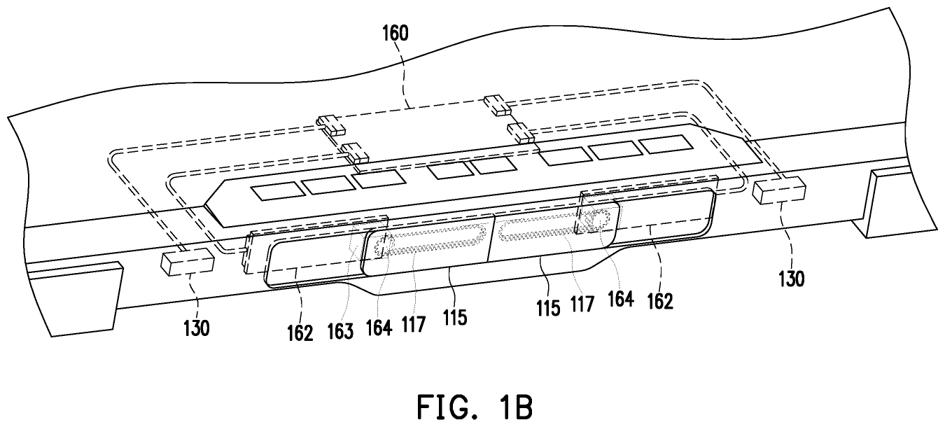

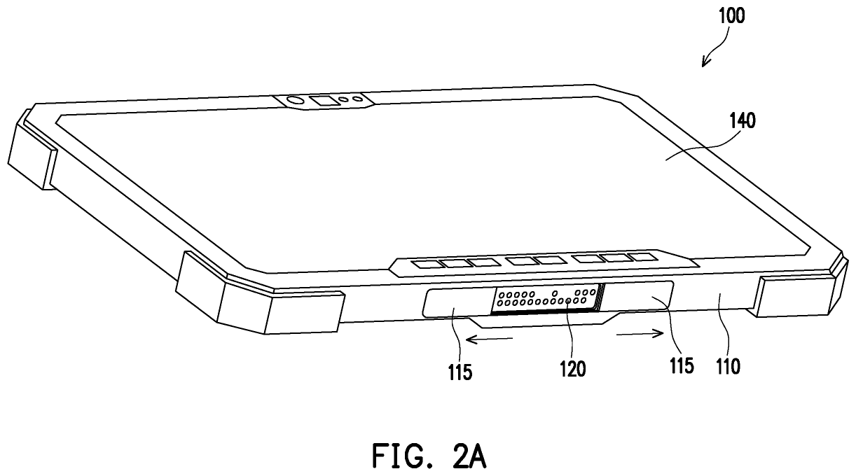

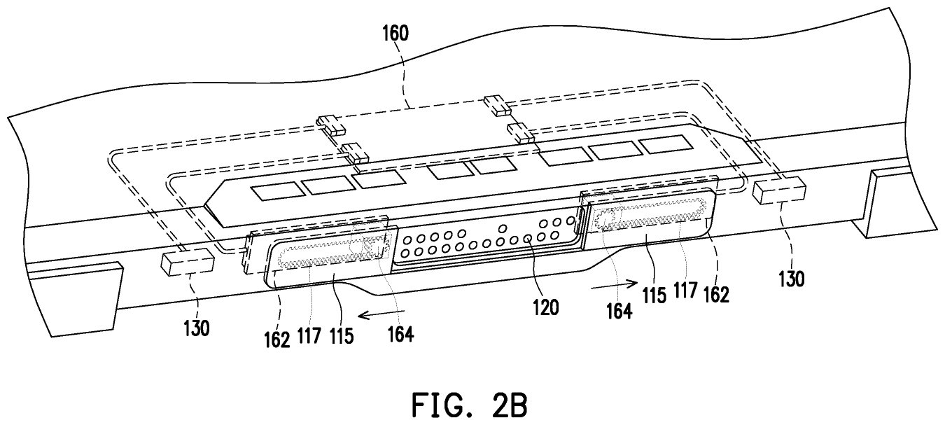

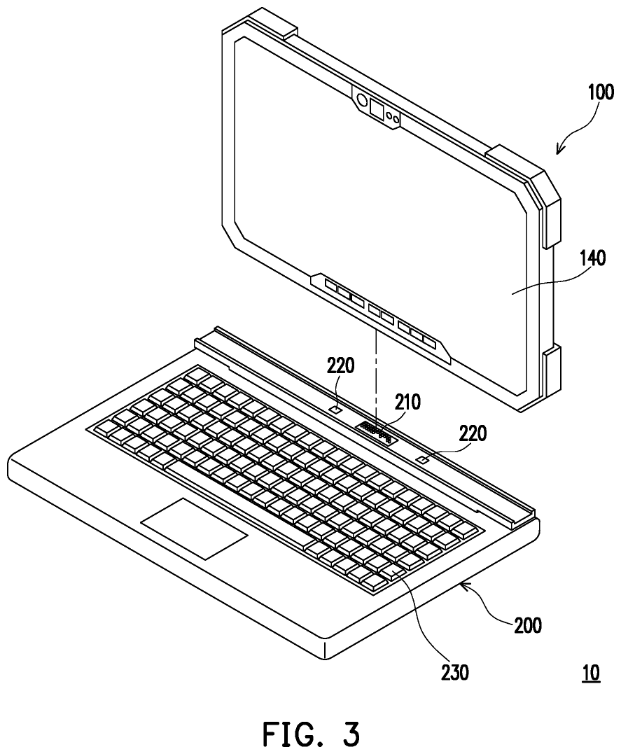

FIG. 1A is a schematic view of a portable electronic device according to an embodiment of the disclosure. FIG. 1B is a partial schematic view of the portable electronic device of FIG. 1A. FIG. 2A is a schematic view of the portable electronic device of FIG. 1A with a second connector thereof exposed. FIG. 2B is a partial schematic view of the portable electronic device of FIG. 2A. FIG. 3 is a schematic view of the portable electronic device and a base of FIG. 1A.

Referring to FIGS. 1A to 3, an electronic system 10 (as shown in FIG. 3) of this embodiment includes a base 200 and a portable electronic device 100. The portable electronic device 100 may be a tablet computer, which may include a touch screen 140. The base 200 may include an input device, such as a keyboard 230. In this embodiment, the portable electronic device 100 may selectively be inserted into the base 200 to form a notebook computer together with the base 200, or the portable electronic device 100 may also be used as a tablet computer alone. The types of the portable electronic device 100 and the base 200 are not limited thereto.

In this embodiment, when the portable electronic device 100 is not inserted into the base 200, a connector used to connect to the base 200 may still be protected. Accordingly, the connector may avoid being easily impacted due to being directly exposed and may also avoid experiencing short circuited caused by an accidental contacting with a metal element. The design will be described in detail below.

As shown in FIG. 3, the base 200 includes a first connector 210 and an RFID (radio frequency identification) tag 220. The first connector 210 includes, for example, multiple pogo pins, but the type of the first connector 210 is not limited thereto. The portable electronic device 100 is detachably disposed on the base 200. As shown in FIGS. 1A to 2B, the portable electronic device 100 includes a casing 110, a second connector 120, a cover 115, a control module 160, and an RFID sensor 130.

In this embodiment, the second connector 120 includes multiple bonding pads and is disposed on a lateral surface 112 of the casing 110. The cover 115 is movably disposed on the lateral surface 112 of the casing 110 and corresponds to the second connector 120, so as to cover or expose the second connector 120 to provide protection to the second connector 120.

In addition, the casing 110 has a groove 114 recessed on the lateral surface 112. The cover 115 is slidably disposed in the groove 114, and the cover 115 is aligned with the lateral surface 112. Such a design may prevent the cover 115 from protruding from the lateral surface 112 of the casing 110, thereby providing desirable aesthetics, and may prevent the cover 115 from being prone to collision and damage due to excessive protrusion. In other embodiments, the cover 115 may protrude from the lateral surface 112 of the casing 110, and is not limited by the drawings.

The control module 160 is disposed in the casing 110 and is coupled to the RFID sensor 130 and the cover 115. The control module 160 may be directly or indirectly connected to the cover 115. Specifically, in this embodiment, the portable electronic device 100 further includes a motor 163, a gear 164 and a rack 117. The motor 163 is disposed in the casing 110 and is electrically connected to the control module 160. The control module 160 is, for example, connected to the motor 163 through a circuit board 162, but the disclosure is not limited thereto. The gear 164 is disposed in the casing 110 and is linked with the motor 163. The rack 117 is disposed on an inner surface of the cover 115 and meshes with the gear 164. The control module 160 is adapted for activating the motor 163, so that the gear 164 rotates and the rack 117 that meshes with the gear 164 moves correspondingly to enable the cover 115 to cover or expose the second connector 120.

In addition, the RFID sensor 130 is disposed in the casing 110 and is adjacent to the lateral surface 112, and the RFID sensor 130 is electrically connected to the control module 160. The RFID sensor 130 may be used to detect the RFID tag 220. Specifically, the RFID sensor 130 is used to detect whether there is an RFID tag (that is, the RFID tag 220) nearby that matches to the RFID sensor 130.

In this embodiment, when the portable electronic device 100 moves away from the base 200, the cover 115 covers the second connector 120 to protect the second connector 120. When the portable electronic device 100 of this embodiment approaches the base 200, the RFID sensor 130 of the portable electronic device 100 detects whether there is an RFID tag nearby. When there is an RFID tag nearby, the RFID sensor 130 determines whether the RFID tag is an RFID tag (that is, the RFID tag 220) that matches to the RFID sensor 130. When the RFID tag is an RFID tag that matches to the RFID sensor 130, the RFID sensor 130 generates a signal and sends the signal to the control module 160. The control module 160 drives the motor 163 according to the received signal, the motor 163 drives the gear 164, and the rack 117 moves through the gear 164 rotating to enable the cover 115 to move to expose the second connector 120. In this embodiment, the control module 160 further controls a power supply module (not shown) to supply power to the second connector 120 according to the received signal.

In this way, during the process of the portable electronic device 100 approaching the base 200 to prepare to be inserted into the base 200, the cover 115 automatically moves open to expose the second connector 120. Accordingly, the portable electronic device 100 may connect to the first connector 210 of the base 200 through the second connector 120.

Similarly, after the portable electronic device 100 is removed from the base 200, the RFID sensor 130 of the portable electronic device 100 detects that the RFID tag (that is, the RFID tag 220 of the base 200) that matches to the RFID sensor 130 has moved away, and the RFID sensor 130 sends another signal to the control module 160. The RFID sensor 130 determines that the RFID tag 220 has moved away according to a weakened electromagnetic field generated by the RFID tag 220. The control module 160 drives the motor 163 to reversely rotate according to the another signal, the motor 163 drives the gear 164, and the gear 164 drives the rack 117 to enable the cover 115 to move and return to the original position to cover the second connector 120. Therefore, during the entire process of inserting and removing the portable electronic device 100, the cover 115 may automatically open or close, thereby providing convenience in operation.

The second connector 120 of the portable electronic device 100 of this embodiment is covered by the cover 115 when the second connector 120 is not connected. Accordingly, the second connector 120 may avoid being directly impacted and may also avoid experiencing short circuited caused by an accidental contacting with a metal element, and the probability of oxidation of the second connector 120 is reduced.

In this embodiment, the control module 160 further controls the power supply module (not shown) to stop supplying power to the second connector 120 according to said another received signal. It is to be noted that, for a typical connector to detect whether there is an external device connected, pins of the connector are usually continuously supplied with power to maintain a detection state. However, in this way, there is static power consumption when the pins of the connector are idle, resulting in extra power consumption. The disposition method of this embodiment may avoid the extra power consumption described above.

In other embodiments, the control module 160 may continuously supply power to the second connector 120 regardless of whether the cover 115 covers or exposes the second connector 120. The disclosure is not limited thereto.

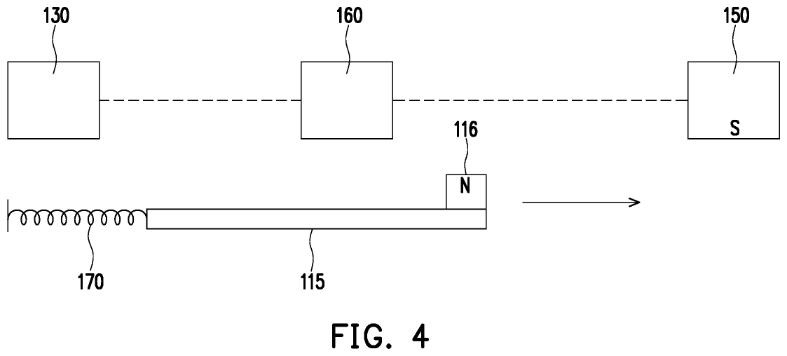

FIG. 4 is a schematic view of a moving cover of another portable electronic device according to an embodiment of the disclosure. Referring to FIG. 4, the main difference between this embodiment and the previous embodiment is that, in the previous embodiment, the cover 115 is driven to move by the motor 163, the gear 164, and the rack 117. In this embodiment, the portable electronic device 100 further includes an electromagnet 150 and a magnetic element 116. The electromagnet 150 is disposed in the casing 110 and is located on a side of the second connector 120, and the electromagnet 150 is electrically connected to the control module 160. The magnetic element 116 is fixed to the cover 115.

When the portable electronic device 100 moves away from the base 200, the control module 160 does not energize the electromagnet 150, and the electromagnet 150 is not magnetic. At this time, the cover 115 covers the second connector 120 to protect second connector 120.

When the portable electronic device 100 approaches the base 200 and the RFID sensor 130 of the portable electronic device 100 detects the RFID tag 220 of the base 200, the RFID sensor 130 generates a signal and transmits the signal to the control module 160. The control module 160 energizes the electromagnet 150 according to the received signal, so that the electromagnet 150 has a magnetism different from that of the magnetic element 116. At this time, the magnetic element 116 is attracted by the electromagnet 150 to enable the cover 115 to move to expose the second connector 120.

In addition, in this embodiment, the portable electronic device 100 further includes an elastic element 170, which is disposed between the casing 110 and the cover 115. When the magnetic element 116 is attracted by the electromagnet 150 to enable the cover 115 to move, the elastic element 170 accumulates an elastic potential energy. When the electromagnet 150 is unenergized, the elastic element 170 releases the elastic potential energy to bring the cover 115 back to cover the second connector 120. In this way, during the process of inserting and removing the portable electronic device 100, the cover 115 may automatically open or close, thereby providing convenience in operation.

In addition, in other embodiments, when the cover 115 includes a ferromagnetic material, the additional magnetic element 116 may be omitted; that is, the cover 115 itself has the function of a magnet. In such an embodiment, when the control module 160 energizes the electromagnet 150, the cover 115 is attracted by the electromagnet 150 to move. Similarly, the cover 115 may also be brought back by the elastic element 170 to cover the second connector 120 to achieve automatic opening and closing of the cover 115.

It is to be noted that in the above embodiment, although the portable electronic device 100 may be a tablet computer and the base 200 is the lower body of the notebook computer, in other embodiments, the portable electronic device 100 may be the lower body of the notebook computer, and the base 200 may include a screen. In other words, the design that may be used to protect the connector described above may also be applied to the lower body of a notebook computer or other devices, and is not limited by the drawings.

In summary, the cover of the portable electronic device of the disclosure is movably disposed at the casing to cover or expose the second connector. When the portable electronic device moves away from base, the cover covers the second connector. When the portable electronic device approaches the base and the RFID sensor of the portable electronic device detects the RFID tag of the base, the RFID sensor generates a signal and sends the signal to the control module to enable the control module to control the cover to move to expose the second connector, so that the second connector of the portable electronic device may connect to the first connector of the base. The second connector of the portable electronic device of the disclosure is covered by the cover when the second connector is not connected. Accordingly, the second connector may avoid being directly impacted and may also avoid experiencing a short circuit caused by an accidental contact with a metal element, and the probability of oxidation of the second connector is reduced. In addition, the cover may automatically open and close as the portable electronic device approaches or moves away from the base, thereby providing convenience in operation.

What is claimed is:

1. A portable electronic device, adapted for connecting to a base, wherein the base comprises a first connector and an RFID (radio frequency identification) tag, and the portable electronic device comprises:
a casing, comprising a lateral surface;
a second connector, disposed on the lateral surface of the casing and adapted for connecting to the first connector;
a cover, movably disposed on the lateral surface of the casing and corresponding to the second connector, so as to cover or expose the second connector;
an RFID sensor, disposed in the casing and adjacent to the lateral surface, wherein the RFID sensor is adapted for detecting the RFID tag to generate a signal; and
a control module, disposed in the casing and coupled to the RFID sensor and the cover, wherein the control module controls the cover to move to expose the second connector according to the signal.

2. The portable electronic device according to claim 1, wherein when the RFID tag moves away from the RFID sensor, the RFID sensor generates another signal and sends the another signal to the control module, and the control module controls the cover to move to cover the second connector according to the another signal.

3. The portable electronic device according to claim 1, further comprising:
a motor, disposed in the casing and electrically connected to the control module;
a gear, disposed in the casing and linked with the motor; and
a rack, disposed on an inner surface of the cover and meshing with the gear, wherein when the motor operates, the rack moves through the gear rotating, so that the cover covers or exposes the second connector.

4. The portable electronic device according to claim 1, further comprising:
an electromagnet, disposed in the casing and located on a side of the second connector, wherein the electromagnet is electrically connected to the control module; and
a magnetic element, fixed to the cover, wherein when the control module receives the signal, the electromagnet is energized, and the magnetic element is attracted by the electromagnet to enable the cover to move to expose the second connector.

5. The portable electronic device according to claim 4, further comprising:
an elastic element, disposed between the casing and the cover, wherein when the magnetic element is attracted by the electromagnet to enable the cover to move, the elastic element accumulates an elastic potential energy, and when the electromagnet is unenergized, the elastic element releases the elastic potential energy to bring the cover back to cover the second connector.

6. The portable electronic device according to claim 1, further comprising:
an electromagnet, disposed in the casing and electrically connected to the control module, wherein the cover comprises a ferromagnetic material, and when the control module energizes the electromagnet, the cover is attracted by the electromagnet to move.

7. The portable electronic device according to claim 6, further comprising:
an elastic element, disposed between the casing and the cover, wherein when the cover moves, the elastic element accumulates an elastic potential energy, and when the electromagnet is unenergized, the elastic element releases the elastic potential energy to bring the cover back to cover the second connector.

8. The portable electronic device according to claim 1, wherein the control module controls a power supply module to supply power to the second connector according to the received signal.

9. The portable electronic device according to claim 1, wherein the casing has a groove recessed on the lateral surface, the cover is slidably disposed at the groove, and the cover is aligned with the lateral surface.

10. An electronic system, comprising:
a base, comprising a first connector and an RFID tag; and
a portable electronic device, comprising:
a casing, comprising a lateral surface;
a second connector, disposed on the lateral surface of the casing and adapted for connecting to the first connector;
a cover, movably disposed on the lateral surface of the casing and corresponding to the second connector, so as to cover or expose the second connector;
an RFID sensor, disposed in the casing and adjacent to the lateral surface, wherein the RFID sensor is adapted for detecting the RFID tag to generate a signal; and
a control module, disposed in the casing and coupled to the RFID sensor and the cover, wherein the control module controls the cover to move to expose the second connector according to the signal, so that the second connector connects to the first connector of the base.
